(19) United States
(12) Patent Application Publication
(10) Pub. No.: US 2017/0043505 A1
(43) Pub. Date: Feb. 16, 2017

(54) COMPRESSION-MOLDING MACHINE FOR MAKING SHOE SOLES

(71) Applicant: TIEN KANG CO., LTD., Taichung City (TW)

(72) Inventor: David HUANG, Taichung City (TW)

(21) Appl. No.: 14/805,466

(22) Filed: Aug. 10, 2015

(51) Int. Cl. B29C 33/30

(52) U.S. Cl. CPC B29C 33/301; B29L 2031/504

(57) ABSTRACT

A compression-molding machine for making shoe soles has two ends equipped with a first moving mold wall and a second moving mold wall, respectively. A fixed mold wall is located between the two moving mold walls. The compression-molding machine uses two pressing cylinders to drive to the two second moving mold walls, respectively, so as to make the two moving mold walls move toward the fixed mold wall, thereby allowing the single machine to perform compression molding with two molds. Since the fixed mold wall is immovable, the two molds when performing compression molding are independent of each other. The first pressing cylinder and the second pressing cylinder can be operated separately, so as to eliminate the problem of the conventional compression molding machine where compression molding can only be performed when both of its two molds are positioned, thereby saving manufacturing time and improving productivity of compression molding.

### BACKGROUND OF THE INVENTION

Technical Field

The present invention relates to compression-molding machines, and more particularly to a compression-molding machine for making shoe soles.

Description of Related Art

A conventional compression-molding machine for making shoe soles, as shown in FIG. 1, is configured to work with two mold slides Z. The two mold slides Z each carry a mold, and the conventional compression-molding machine comprises a main body 60, a moving mold wall 70, and a fixed mold wall 90.

The main body 60 has two opposite lateral walls 61. At one of the two corresponding end pairs of the lateral wall 61, there is a top wall 62 located between the two lateral walls 61. At the other corresponding end pair of the two lateral walls 61, there is a pressing cylinder 63 located between the two lateral walls 61. The two lateral walls 61, the top wall 62 and the pressing cylinder 63 jointly form an accommodating space 64. The accommodating space 64 has a first open side 641 and a second open side 642 opposite to each other. A direction running from the first open side 641 to the second open side 642 or vice versa is defined as a sliding direction X, while a direction running from the pressing cylinder 63 to the top wall 62 or vice versa is defined as an acting direction Y. Two mold slides Z are attached to the machine at the first open side 641 and the second open side 642, respectively.

The moving mold wall 70 is configured to be driven by the pressing cylinder 63 and is located within the accommodating space 64. When driven by the pressing cylinder 63, the moving mold wall 70 moves inside the accommodating space 64 in the acting direction Y.

The sliding mold wall 80 has its two ends slidably in the acting direction Y mounted on the two lateral walls 61, so that the sliding mold wall 80 is allowed to move inside the accommodating space 64 in the acting direction Y. The moving mold wall 70 faces the sliding mold wall 80, so that a first hot-pressing space R1 is formed between the moving mold wall 70 and the sliding mold wall 80. One of the mold slide Z faces the first hot-pressing space R1.

The fixed mold wall 90 is fixed to a side of the top wall 62 that faces the accommodating space 64. The fixed mold wall 90 faces the sliding mold wall 80, so that a second hot-pressing space R2 is formed between the fixed mold wall 90 and the sliding mold wall 80. The other mold slide Z faces the second hot-pressing space R2.

The conventional compression-molding machine for making shoe soles operates as below. First, the two mold slides Z each deliver the molds where compression molding is to be performed to the first hot-pressing space R1 and the second hot-pressing space R2 of the main body 60 in the sliding direction X. When the two molds are positioned, the machine uses the pressing cylinder 63 to drive the moving mold wall 70 to move in the acting direction Y toward the sliding mold wall 80. While the moving mold wall 70 and the sliding mold wall 80 press the mold in the first hot-pressing space R1, the sliding mold wall 80 also moves in the sliding direction X toward the fixed mold wall 90, so as to press the mold in the second hot-pressing space R2 simultaneously, thereby performing compression molding with two molds at the same time.

The conventional compression-molding machine uses the pressing cylinder 63 to drive the moving mold wall 70 to move toward the sliding mold wall 80, thereby driving the sliding mold wall 80 to move toward the fixed mold wall 90 to perform compression molding with two molds at the same time. However, since the sliding mold wall 80 is slidable, the two molds unavoidably interact during compression molding. For this reason, compression molding can only be performed when the two molds are positioned in the first hot-pressing space R1 and the second hot-pressing space

R2, respectively. In practical operation, where time difference exists between the manufacturing processes using the two molds, the first positioned mold has to be set idle until the later mold reaches its position. This waiting can significantly prolong the manufacturing and harm the productivity. Hence, there is a need for a compression-molding machine that makes shoe soles with high efficiency.

### SUMMARY OF THE INVENTION

The primary objective of the present invention is to provide a compression-molding machine for making shoe soles that provides better efficiency and productivity as compared to the prior art.

The disclosed compression-molding machine for making shoe soles, the compression-molding machine is configured to work with two mold slides that each carry a mold, and the compression-molding machine comprises:

a main body, having two opposite lateral walls, wherein at one corresponding end pair of the two lateral walls there is a first pressing cylinder located between the two lateral walls, and at an opposite corresponding end pair of the two lateral walls there is a second pressing cylinder located between the two lateral walls, so that the two lateral walls, the first pressing cylinder, and the second pressing cylinder jointly form an accommodating space that has a first open side and a second open side opposite to each other, in which a direction running from the first open side to the second open side or vice versa is defined as a sliding direction, while a direction running from the first pressing cylinder to the second pressing cylinder or vice versa is defined as an acting direction, and the two mold slides are attached to the compression-molding machine at the first open side and the second open side, respectively;

a first moving mold wall, being configured to be driven by the first pressing cylinder and being located in the accommodating space;

a second moving mold wall, being configured to be driven by the second pressing cylinder and being located in the accommodating space; and

at least one fixed mold wall, being located between the first moving mold wall and the second moving mold wall, and having two ends thereof fixed to the two lateral walls, so that a first hot-pressing space is formed between the fixed mold wall and the first moving mold wall with one of the mold slides facing the first hot-pressing space, and a second hot-pressing space is formed between the fixed mold wall and the second moving mold wall with the other mold slide facing the second hot-pressing space.

The disclosed compression-molding machine uses the first pressing cylinder to drive the first moving mold wall and uses the second pressing cylinder to drive the second moving mold wall, so as to make the first moving mold wall and the second moving mold wall move toward the fixed mold wall, thereby allowing the single machine to perform compression molding with two molds. Since the fixed mold wall is immovable, the two molds when performing compression molding are independent of each other. The first pressing cylinder and the second pressing cylinder can be operated separately, so as to eliminate the problem of the conventional compression molding machine where compression molding can only be performed when both of its two molds are positioned, thereby saving manufacturing time and improving productivity of compression molding.

### BRIEF DESCRIPTION OF THE DRAWINGS

FIG. 1 is a perspective view of a conventional compression-molding machine for making shoe soles.

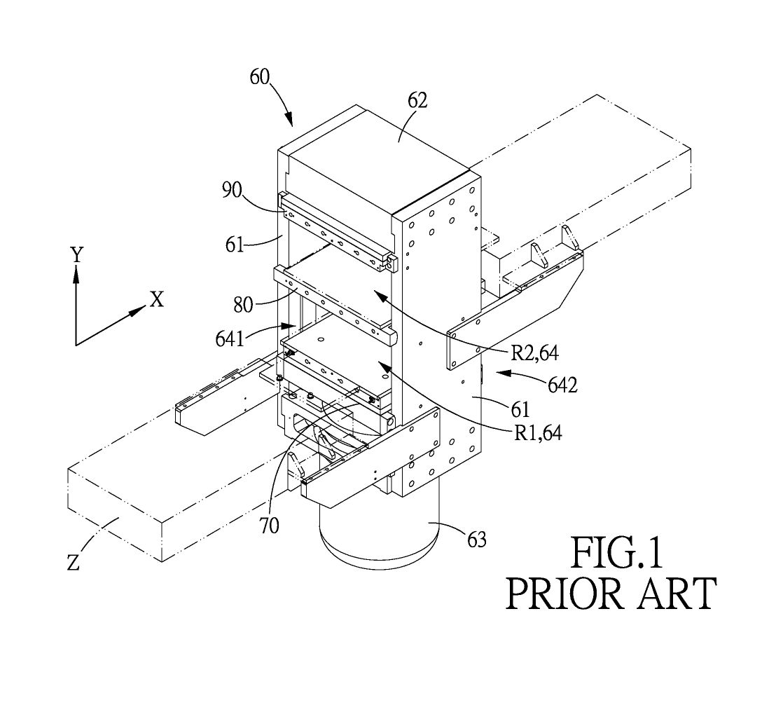

FIG. 2 is a front view of a compression-molding machine for making shoe soles according to the present invention.

FIG. 3 is a perspective view of the compression-molding machine for making shoe soles according to the present invention.

### DETAILED DESCRIPTION OF THE INVENTION

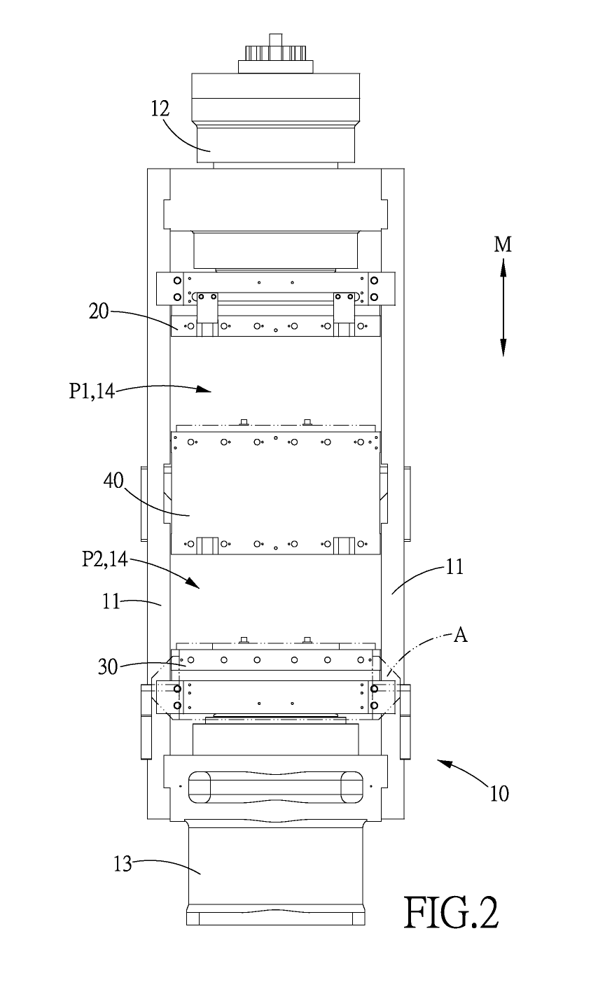

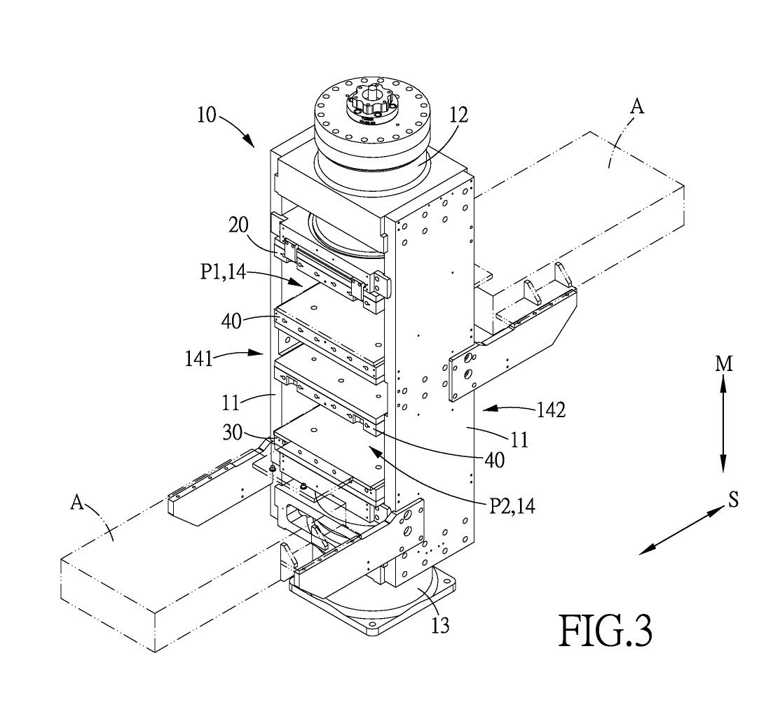

A compression-molding machine for making shoe soles according to the present invention is shown in FIG. 2 and FIG. 3, and is configured to work with two mold slides A that each carry a mold. The disclosed compression-molding machine for making shoe soles comprises a main body 10, a first moving mold wall 20, a second moving mold wall 30, and at least one fixed mold wall 40.

The main body 10 has two opposite lateral walls 11. A first pressing cylinder 12 is set at one of the two corresponding end pairs of the two lateral walls 11 and located between the two lateral walls 11 and connected thereto. A second pressing cylinder 13 is set at the other corresponding end pair of the two lateral walls 11 and between the two lateral walls 11 and connected thereto. The two lateral walls 11, the first pressing cylinder 12, and the second pressing cylinder 13 jointly define an accommodating space 14.

The accommodating space 14 has a first open side 141 and a second open side 142 that are opposite to each other. It is herein defined that a direction from the first open side 141 to the second open side 142 is a sliding direction S, and a direction from the first pressing cylinder 12 to the second pressing cylinder 13 is an acting direction M. The two mold slides A are located at the first open side 141 and the second open side 142, respectively.

The first moving mold wall 20 is configured to be driven by the first pressing cylinder 12. The first moving mold wall 20 is located in the accommodating space 14, and when driven by the first pressing cylinder 12, moves in the acting direction M inside the accommodating space 14.

The second moving mold wall 30 is configured to be driven by the second pressing cylinder 13. The second moving mold wall 30 is located in the accommodating space 14, and when driven by the second pressing cylinder 13, moves in the acting direction M inside the accommodating space 14.

The fixed mold wall 40 is located between the first moving mold wall 20 and the second moving mold wall 30. The fixed mold wall 40 has its two ends fixed to the two lateral walls 11 so that a first hot-pressing space P1 is formed between the fixed mold wall 40 and the first moving mold wall 20 and one of the mold slides A faces the first hot-pressing space P1, while a second hot-pressing space P2 is formed between the fixed mold wall 40 and the second moving mold wall 30 and the other mold slide A faces the second hot-pressing space P2.

In one embodiment of the present invention, there are two fixed mold walls 40. One of the fixed mold walls 40 and the first moving mold wall 20 define the first hot-pressing space P1, while the other fixed mold wall 40 and the second moving mold wall 30 define the second hot-pressing space P2.

The disclosed compression-molding machine operates as below. First, the two mold slides A deliver the molds where compression molding is to be performed to the first hot-pressing space P1 and the second hot-pressing space P2 of the main body 10 in the sliding direction S, respectively. After the two molds are positioned, the machine uses the first pressing cylinder 12 and the second pressing cylinder 13 to drive the first moving mold wall 20 and the second moving mold wall 30, respectively, so that the first moving mold wall 20 and the second moving mold wall 30 move in the acting direction M toward the fixed mold wall 40. Since the two ends of the fixed mold wall 40 are fixed to the two lateral walls 11, the fixed mold wall 40 stays immovable inside the accommodating space 14. Thereby, the first moving mold wall 20 and the fixed mold wall 40 can press the mold in the first hot-pressing space P1, while the second moving mold wall 30 and the fixed mold wall 40 press the mold in the second hot-pressing space P2, thereby performing compression molding with two molds at the same time.

It is clear from the previous description that the compression-molding machine uses the first pressing cylinder 12 to drive the first moving mold wall 20 and uses the second pressing cylinder 13 to drive the second moving mold wall 30, so as to make the first moving mold wall 20 and the second moving mold wall 30 move toward the fixed mold wall 40, thereby allowing the single machine to perform compression molding with two molds. Since the fixed mold wall 40 is immovable, the two molds when performing compression molding are independent of each other. The first pressing cylinder 12 and the second pressing cylinder 13 can be operated separately, so as not to have to wait for the two molds to be positioned in the first hot-pressing space P1 and the second hot-pressing space P2 before performing compression molding, thereby saving manufacturing time and improving productivity of compression molding.

What is claimed is:

1. A compression-molding machine for making shoe soles, the compression-molding machine being configured to work with two mold slides that each carry a mold, and the compression-molding machine comprising:
a main body having two opposite lateral walls, a first pressing cylinder located between the two lateral walls and connected to the two lateral walls, and a second pressing cylinder located between the two lateral walls and connected to the two lateral walls, wherein the two lateral walls, the first pressing cylinder, and the second pressing cylinder jointly form an accommodating space that has a first open side and a second open side opposite to each other, in which a direction running from the first open side to the second open side or vice versa is defined as a sliding direction, while a direction running from the first pressing cylinder to the second pressing cylinder or vice versa is defined as an acting direction, and the two mold slides are attached to the compression-molding machine at the first open side and the second open side, respectively;
a first moving mold wall being configured to be driven by the first pressing cylinder and being located in the accommodating space;
a second moving mold wall being configured to be driven by the second pressing cylinder and being located in the accommodating space; and
at least one fixed mold wall being located between the first moving mold wall and the second moving mold wall, and having two ends thereof fixed to the two lateral walls, so that a first hot-pressing space is formed between the fixed mold wall and the first moving mold wall with one of the mold slides facing the first hot-pressing space, and a second hot-pressing space is formed between the fixed mold wall and the second moving mold wall with the other one of the mold slides facing the second hot-pressing space.

2. The compression-molding machine of claim 1, wherein the at least one fixed mold wall comprises two said fixed mold walls; the first hot-pressing space is formed between one of the fixed mold walls and the first moving mold wall, while the second hot-pressing space is formed between the other one of the fixed mold walls and the second moving mold wall.
